(19) United States
(12) Patent Application Publication
(10) Pub. No.: US 2016/0162199 A1
(43) Pub. Date: Jun. 9, 2016

(54) MULTI-PROCESSOR COMMUNICATION SYSTEM SHARING PHYSICAL MEMORY AND COMMUNICATION METHOD THEREOF

(71) Applicant: SAMSUNG ELECTRONICS CO., LTD., Suwon-si (KR)

(72) Inventor: Hongfei Tang, HangZhou (CN)

(73) Assignee: SAMSUNG ELECTRONICS CO., LTD., Suwon-si (KR)

(21) Appl. No.: 14/959,520

(22) Filed: Dec. 4, 2015

(30) Foreign Application Priority Data
Dec. 5, 2014 (CN) 201410734202.9
Jun. 12, 2015 (KR) 10-2015-0083668

(51) Int. Cl. G06F 3/06; G06F 13/16; G06F 13/42

(52) U.S. Cl. CPC G06F 3/0608; G06F 3/0644; G06F 3/0673; G06F 13/4282; G06F 13/1663

(57) ABSTRACT

A multi-processor communication system sharing a memory and a communication method thereof are provided. The multi-processor communication system includes a plurality of processors configured to share data with one another; and the physical memory divided into a plurality of physical memory blocks, wherein each of the processors has one dedicated physical memory block among the plurality of physical memory blocks, wherein a processor among the plurality of processors is configured, as a transmission processor, to transmit data to a dedicated physical memory block of another processor among the plurality of processors, which is configured, as a reception processor, to receive data, and wherein the reception processor reads the data from the dedicated physical memory block of the reception processor.

### CROSS-REFERENCE TO RELATED APPLICATIONS

This application claims priority from Chinese Patent Application No. 201410734202.9, filed on Dec. 5, 2014 in the Chinese Intellectual Property Office, and Korean Patent Application No. 10-2015-0083668, filed on Jun. 12, 2015 in the Korean Intellectual Property Office, the disclosures of which are incorporated by reference herein in their entireties.

### BACKGROUND

1. Field

Systems, apparatuses, and methods consistent with the present disclosure relate to multi-processor communication, and more particularly, to a communication system for performing communication among a plurality of processors sharing a physical memory, and a communication method thereof.

2. Description of the Related Art

In a multi-processor communication system, a plurality of processors exchange data with one another via a serial communication interface, such as universal asynchronous receiver transmitter (UART), universal serial bus (USB), and serial peripheral interface (SPI). When a serial communication interface is used for communication, peripheral circuits become complex and a transmission speed decreases. As a result, it is hard to perform communication which includes a large volume of data or which requires high-speed communication among the plurality of processors.

### SUMMARY

One or more exemplary embodiments provide a multi-processor communication system configured to perform communication among a plurality of processors sharing a physical memory, in order to increase a memory use efficiency and a data transmission speed.

One or more exemplary embodiments also provide a communication method of the multi-processor communication system.

According to an aspect of an exemplary embodiment, there is provided a multi-processor communication system sharing a physical memory, the multi-processor communication system including a plurality of processors configured to share data with one another; and the physical memory divided into a plurality of physical memory blocks, wherein each of the processors has one dedicated physical memory block among the plurality of physical memory blocks, wherein a processor among the plurality of processors is configured, as a transmission processor, to transmit data to a dedicated physical memory block of another processor among the plurality of processors, which is configured, as a reception processor, to receive data, and wherein the reception processor reads the data from the dedicated physical memory block of the reception processor.

According to an aspect of another exemplary embodiment, there is provided a communication method of a multi-processor communication system which includes a physical memory and a plurality of processors exchanging data with each other and sharing the physical memory, the communication method including dividing the physical memory into a plurality of physical memory blocks so that each of the processors has one dedicated physical memory block among the plurality of physical memory blocks; transmitting the data to a dedicated physical memory block of a reception processor, which receives data, from among the plurality of processors, the transmitting being performed by a transmission processor, which transmits data, from among the plurality of processors; and reading the data from the dedicated physical memory block of the reception processor.

According to an aspect of another exemplary embodiment, there is provided a multi-processor communication system comprising a first processor; a second processor that exchanges data with the first processor; and a physical memory, wherein the second processor has one dedicated physical memory block in the physical memory, and wherein the second processor temporarily allocates a temporary data buffer area of its dedicated physical memory block for receiving data transmitted only from the first processor.

### BRIEF DESCRIPTION OF THE DRAWINGS

Exemplary embodiments will be more clearly understood from the following detailed description taken in conjunction with the accompanying drawings in which:

FIG. 1 is a block diagram of a multi-processor communication system sharing a physical memory, according to an exemplary embodiment;

FIG. 2 is a flowchart of a communication method of a multi-processor communication system sharing a physical memory, according to an exemplary embodiment;

FIG. 3 is a view for describing communication of a multi-processor communication system sharing a physical memory, according to another exemplary embodiment;

FIG. 4 is a flowchart of a communication method of a multi-processor communication system sharing a physical memory, according to another exemplary embodiment;

FIG. 5 is a view of a message box according to an exemplary embodiment;

FIG. 6 is a view for describing an example of a multi-processor communication system sharing a physical memory with respect to burst data, according to an exemplary embodiment;

FIG. 7A is a flowchart of an operation of a transmission processor of a multi-processor communication system sharing a physical memory with respect to burst data, according to an exemplary embodiment;

FIG. 7B is a flowchart of an operation of a reception processor of a multi-processor communication system sharing a physical memory with respect to burst data, according to an exemplary embodiment;

FIG. 8 is a view for describing an example of a multi-processor communication system sharing a physical memory with respect to stream data, according to an exemplary embodiment;

FIGS. 9A and 9B are flowcharts of an operation of a transmission processor of a multi-processor communication system sharing a physical memory with respect to stream data, according to an exemplary embodiment; and

FIGS. 9C and 9D are flowcharts of an operation of a reception processor of a multi-processor communication system sharing a physical memory with respect to stream data, according to an exemplary embodiment.

### DETAILED DESCRIPTION

Hereinafter, the inventive concept will now be described more fully with reference to the accompanying drawings, in which exemplary embodiments t are shown. Like reference numerals in the drawings denote like elements, and a repeated explanation will not be given of overlapping features. Expressions such as “at least one of,” when preceding a list of elements, modify the entire list of elements and do not modify the individual elements of the list. As used herein, the term “and/or” includes any and all combinations of one or more of the associated listed items. These inventive concepts may, however, be embodied in different forms and should not be construed as limited to the exemplary embodiments set forth herein. Rather, these exemplary embodiments are provided so that this disclosure is thorough and complete and fully conveys the inventive concept to those skilled in the art. It should be understood that exemplary embodiments of the inventive concept are to cover all modifications, equivalents, and alternatives falling within the spirit and scope of the inventive concept. In the attached drawings, sizes of structures may be exaggerated for clarity.

The terminology used herein is for describing particular exemplary embodiments and is not intended to be limiting of exemplary embodiments. As used herein, the singular forms “a,” “an,” and “the,” are intended to include the plural forms as well, unless the context clearly displays otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Unless otherwise defined, all terms (including technical and scientific terms) used herein have the same meanings as commonly understood in the art to which the exemplary embodiments belong. It will be further understood that the terms such as those defined in commonly used dictionaries should be interpreted as having meanings consistent with their meanings in the context of the relevant art and will not be interpreted in an idealized or overly formal sense unless expressly so defined herein.

When a plurality of processors exchange data with one another in a multi-processor system sharing a physical memory, peripheral circuits are not required. In addition, an access speed is high and real time performance is good. In particular, in the multi-processor system sharing a physical memory, the physical memory is divided into a plurality of dedicated physical memory blocks so that each processor may have one dedicated physical memory block to run a dedicated software system. Furthermore, with respect to the data communication among the plurality of processors, the physical memory block may be reserved in the physical memory, as a globally shared memory area which includes a data sharing buffer area storing communication data among the processors and a state sharing buffer area storing and updating a state of the data sharing buffer area.

In general, to perform communication in the multi-processor system sharing a physical memory, a relatively large globally shared memory area is required, and a portion of a memory space, which corresponds to the globally shared memory area, is required to be formed according to a usage plan, for example, a specific hardware system, such as a product design specification, the actual number of processors, an application scenario of each processor, etc. This type of method employing a usage plan may have several disadvantages.

First, when the globally shared memory area is reserved for a long time, memory waste is caused. Once the globally shared memory area is fixedly planned, the determined data sharing buffer area and state sharing buffer area are dynamically released and are not reused, and thus, the determined data sharing buffer area and state sharing buffer area may not be used for other purposes.

Second, the usage plan of the globally shared memory area is not flexible. When it is requested to change a memory layout according to certain reasons, it is required to calculate and change parameters in a software system of each processor. This is inconvenient and error-prone.

Third, it is required to perform a data copy operation twice in the data communication process among the plurality of processors. That is, it is required to copy data from a transmission processor to the globally shared memory area, and then, it is required to copy the data from the globally shared memory area to a reception processor.

When data is transmitted in the multi-processing system sharing a physical memory, the use efficiency of the physical memory may be reduced and a data transmission speed may decrease.

By contrast, according to exemplary embodiments, there is provided a multi-processor communication system sharing a physical memory, and a communication method, which are capable of increasing the memory use efficiency and the data transmission speed.

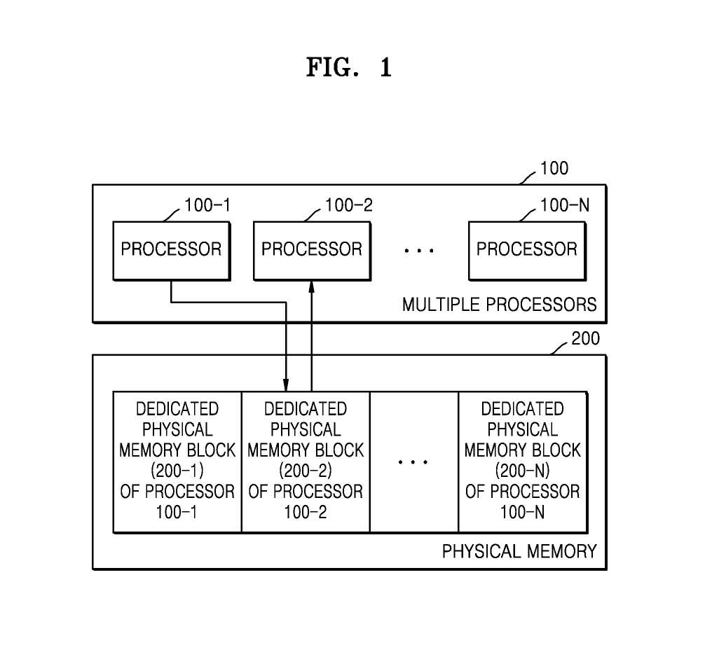

FIG. 1 is a block diagram of a multi-processor communication system sharing a physical memory, according to an exemplary embodiment.

Referring to FIG. 1, the multi-processor communication system sharing a physical memory (hereinafter, referred to as “the multi-processor communication system”), according to the present exemplary embodiment, includes a plurality of processors 100 and a physical memory 200. The multi-processor communication system may be integrated into one chip system. According to an exemplary embodiment, the multi-processor communication system may be integrated into a multi-processor system sharing a multi-port physical memory. The processors 100 may be central processors, microprocessors, physical processors, digital signal processors, etc. The physical memory 200 may be, for example, random access memory (RAM).

The plurality of processors 100 may include, for example, a first processor 100-1, a second processor 100-2, . . . , and an n^{th} processor 100-N, and may exchange data with one another.

The physical memory 200 is divided into a plurality of physical memory blocks so that each of the processors has one dedicated physical memory block. That is, each of the processors has a corresponding dedicated physical memory block. The physical memory 200 may be divided into a first dedicated physical memory block 200-1 of the first processor 100-1, a second dedicated physical memory block 200-2 of the second processor 100-2, . . . , and an n^{th} dedicated physical memory block 200-N of the n^{th} processor 100-N.

A transmission processor, which is configured to transmit data, from among the plurality of processors 100, transmits data to a dedicated physical memory block of a reception processor, which is configured to receive data, from among the plurality of processors 100, and the reception processor reads the data from its own dedicated physical memory block.

For convenience of explanation, it is assumed that the first processor 100-1 is the transmission processor transmitting data and the second processor 100-2 is the reception processor receiving the data. The transmission processor and the reception processor are not limited to the first processor 100-1 and the second processor 100-2, and may be other processors from among the plurality of processors 100. Also, any one processor may be used not only to transmit data, but also to receive data. That is, when the processor transmits data, the processor may be used as a transmission processor, and when the processor receives data, the processor may be used as a reception processor. In other words, for any given transaction, any of the plurality of processors 100 may be used as the transmission processor, and any of the remaining plurality of processors 100 may be used as the reception processor.

The first processor 100-1 may transmit data to the second dedicated physical memory block 200-2 of the second processor 100-2, and the second processor 100-2 may read the data from the second dedicated physical memory block 200-2.

In the multi-processor communication system sharing a physical memory, according to the present exemplary embodiment, a globally shared memory area does not have to be reserved, and the plurality of processors 100 may transmit data to one another via the dedicated physical memory blocks 200-1, 200-2, . . . , and 200-N corresponding to the plurality of processors 100, respectively, and thus, a memory use efficiency and a data transmission speed may be improved.

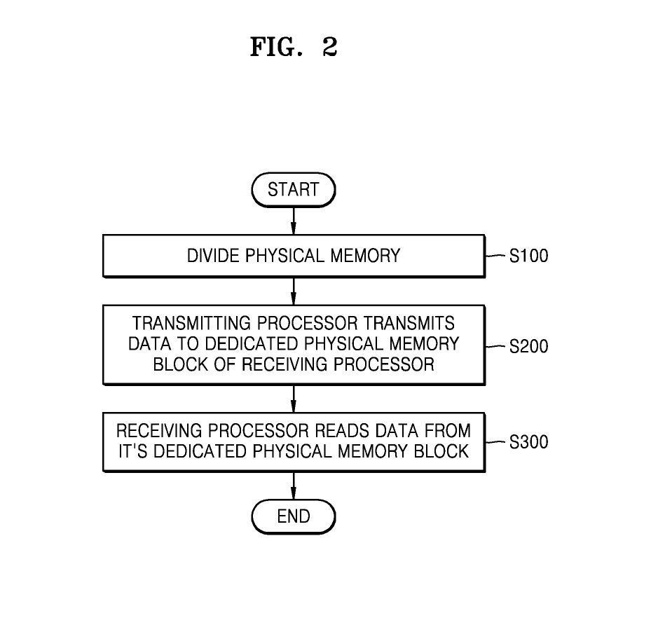

FIG. 2 is a flowchart of a communication method of a multi-processor communication system sharing a physical memory (hereinafter, referred to as “the multi-processor communication method”), according to an exemplary embodiment. The multi-processor communication system includes a plurality of processors and a physical memory, an example of which is described above, and the plurality of processors transmit and receive data to and from one another. For example, the processors may be central processors, microprocessors, physical processors, digital signal processors, etc. The physical memory may be, for example, RAM. The multi-processor communication system may be integrated into one chip system. According to an exemplary embodiment, the multi-processor communication system may be integrated into a multi-processor system sharing a multi-port physical memory.

Referring to FIG. 2, in operation S100, the physical memory is divided into a plurality of physical memory blocks. Each of the processors has one dedicated physical memory block.

In operation S200, a transmission processor, which is configured to transmit data, from among the plurality of processors 100, transmits data to a dedicated physical memory block of a reception processor, which is configured to receive data, from among the plurality of processors 100.

In operation S300, the reception processor reads the data from its own dedicated physical memory block. For example, any one processor may be used not only to transmit data, but also to receive data. That is, when the processor transmits data, the processor may be used as a transmission processor, and when the processor receives data, the processor may be used as a reception processor. In other words, for any given transaction, any of the plurality of processors 100 may be used as the transmission processor, and any of the remaining plurality of processors 100 may be used as the reception processor.

According to the communication method of the multi-processor communication system sharing a physical memory according to the present exemplary embodiment, a globally shared memory area does not have to be reserved, and the plurality of processors may transmit data to one another via the dedicated physical memory blocks corresponding to the plurality of processors 100, respectively, and thus, a memory use efficiency and a data transmission speed may be improved.

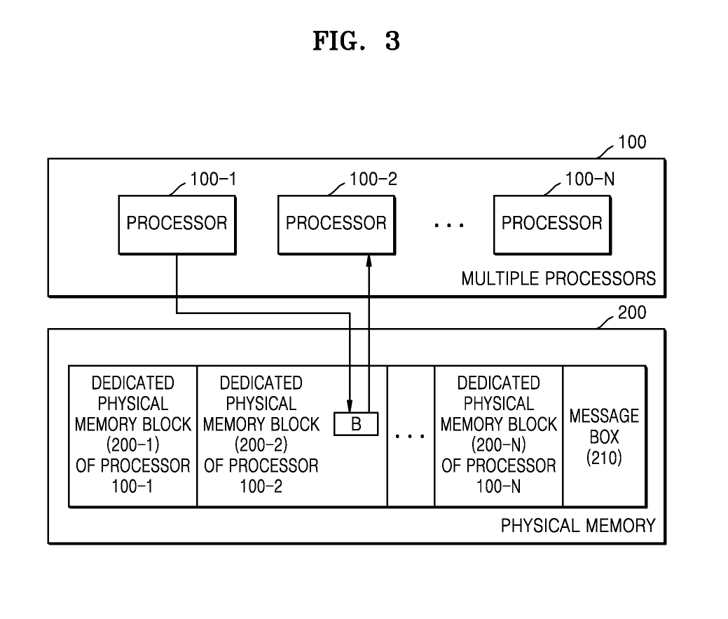

FIG. 3 is a view for describing communication of the multi-processor communication system sharing a physical memory, according to another exemplary embodiment.

Referring to FIG. 3, the plurality of processors 100 include the transmission processor (that is, for example, the first processor 100-1) and the reception processor (that is, for example, the second processor 100-2). The first processor 100-1 may request the second processor 100-2 to allocate a temporary data buffer area B for buffering data in the second dedicated physical memory block 200-2, and the second processor 100-2 may allocate the temporary data buffer area B in response to the request of the first processor 100-1. The temporary data buffer area B may be used to temporarily store the data that the transmission processor is to transmit to the reception processor.

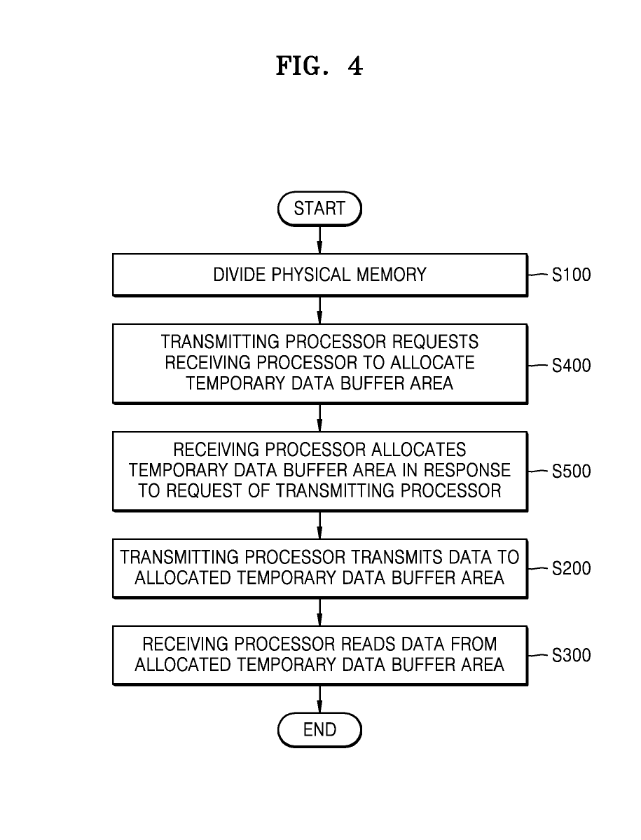

FIG. 4 is a flowchart of a communication method of a multi-processor communication system sharing a physical memory, according to another exemplary embodiment.

Referring to FIG. 4, in operation S100, the physical memory is divided into a plurality of physical memory blocks. Each of a plurality of processors has one dedicated physical memory block.

In operation S400, a transmission processor may request a reception processor to allocate a temporary data buffer area for buffering data in a dedicated physical memory block of the reception processor.

In operation S500, the reception processor may allocate the temporary data buffer area in response to the request of the transmission processor.

In operation S200, the transmission processor may transmit data to the allocated temporary data buffer area.

In operation S300, the reception processor may read the data from the allocated temporary data buffer area.

Here, according to actual application scenarios and plans for allocating and releasing the temporary data buffer area, the data exchanged among the plurality of processors of the multi-processor communication system may include burst data and stream data.

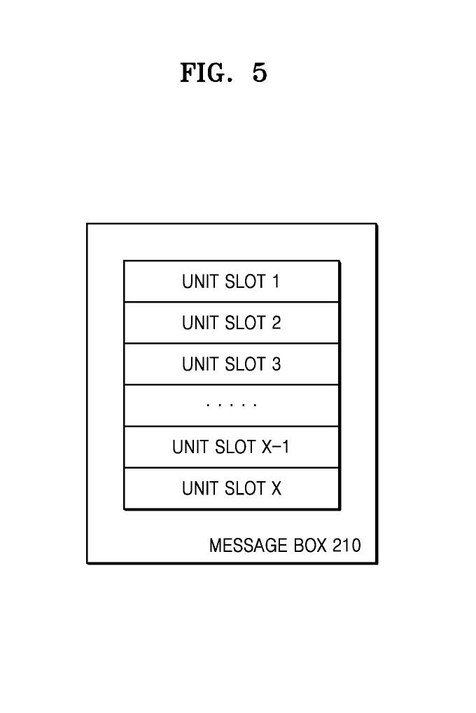

Also, as shown in FIG. 5, the multi-processor communication system may further include a message box 210 for temporally storing a plurality of messages having semantemes. Each of the plurality of processors of the multi-processor communication system according to the exemplary embodiments may access the message box 210. For example, the message box 210 may be a dedicated area divided from the physical memory, that is, a portion of the physical memory. According to exemplary embodiments, the message box 210 may be a dedicated hardware register provided in the multi-processor communication system. The message box 210 may be a dedicated area divided from the physical memory 200 of FIG. 3, that is, a portion of the physical memory 200. Hereinafter, the message box 210 according to the present exemplary embodiment will be described by referring to FIG. 5.

As illustrated in FIG. 5, the message box 210 may be divided into X unit slots. According to an actual application, X may be 16, 32, 64, or other integers. Each of the X unit slots may be set to have a fixed same size. Each of the X unit slots is loaded with one message having a sementeme.

The message may be a command of a party participating in data communication with another party to perform an operation, for example, a command of the transmission processor with respect to the reception processor to allocate a temporary data buffer area. According to exemplary embodiments, the message may be a response after the command is executed, for example, a response after the reception processor allocates the temporary data buffer area in response to the command of the transmission processor.

Each of the messages may include processor identifiers indicating both parties participating in data communication, that is, the message transmitter and the message receiver. In addition, each unit slot may be loaded with a permanent message. The unit slot loaded with the permanent message is used for a relatively long time and is not set in an idle or an available state, and thus, the both communicating parties may use the unit slot loaded with the permanent message preferentially. Accordingly, a message transmission efficiency may be improved.

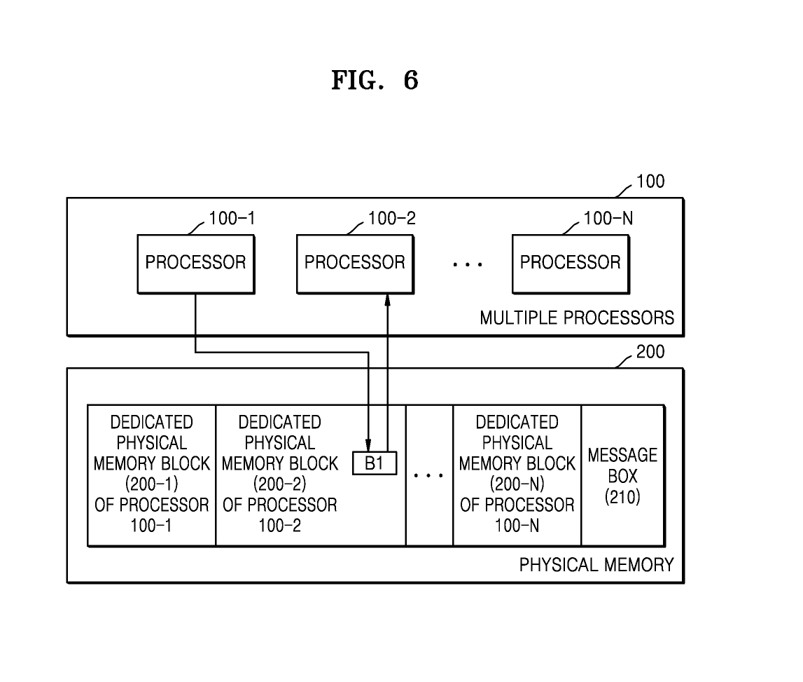

FIG. 6 is a view for describing an example of a multi-processor communication system sharing a physical memory with respect to burst data, according to an exemplary embodiment.

Referring to FIG. 6, when, for example, data that the transmission processor is to transmit to the reception processor is burst data, the temporary data buffer area B for buffering the burst data may include a single buffer area B1.

The burst data may be understood to indicate data that is transmitted in a burst mode during data communication. A burst data message including type information indicating a burst data transmission event may be temporarily stored in the message box 210. For example, the burst data transmission event may include at least one of an event in which an allocation of a temporary data buffer area is requested, an event in which the temporary data buffer area is allocated, an event in which data that is to be read is stored in the temporary data buffer area, and an event in which the data stored in the temporary data buffer area is read.

When the burst data transmission event is the event in which the allocation of the temporary data buffer area is requested, the burst data message may include a request parameter related to the request of the allocation of the temporary data buffer area. The request parameter may include a size of the requested single buffer area B1, an application identifier for identification with respect to other requests of the same processor, an identifier of the transmission processor, and an identifier of the reception processor.

When the burst data transmission event is the event in which the temporary data buffer area is allocated, the burst data message may include an allocation parameter related to the allocation of the temporary data buffer area. The allocation parameter may include a size and a location of the allocated single buffer area B1, an application identifier, an identifier of the transmission processor, and an identifier of the reception processor.

When the burst data transmission event is the event in which data that is to be read is stored in the temporary data buffer area, the burst data message may store a parameter related to the storage of the data that is to be read in the temporary data buffer area. The parameter related to the storage of the data may include an address of a single buffer area, a length of the data that is to be read, an application identifier, an identifier of the transmission processor, and an identifier of the reception processor.

When the burst data transmission event is the event in which the data stored in the temporary data buffer area is read, the burst data message may store a parameter related to the reading of the data in the temporary data buffer area. The parameter related to the data reading may include an address of a single buffer area, an application identifier, an identifier of the transmission processor, and an identifier of the reception processor.

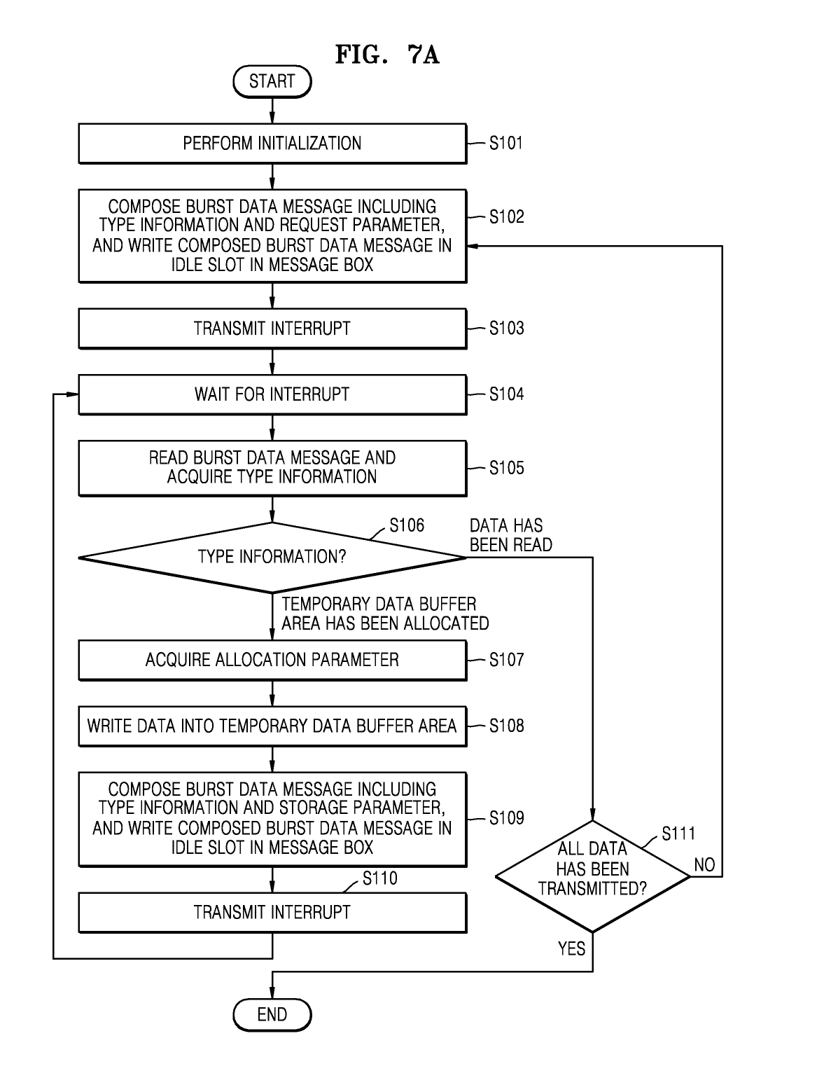

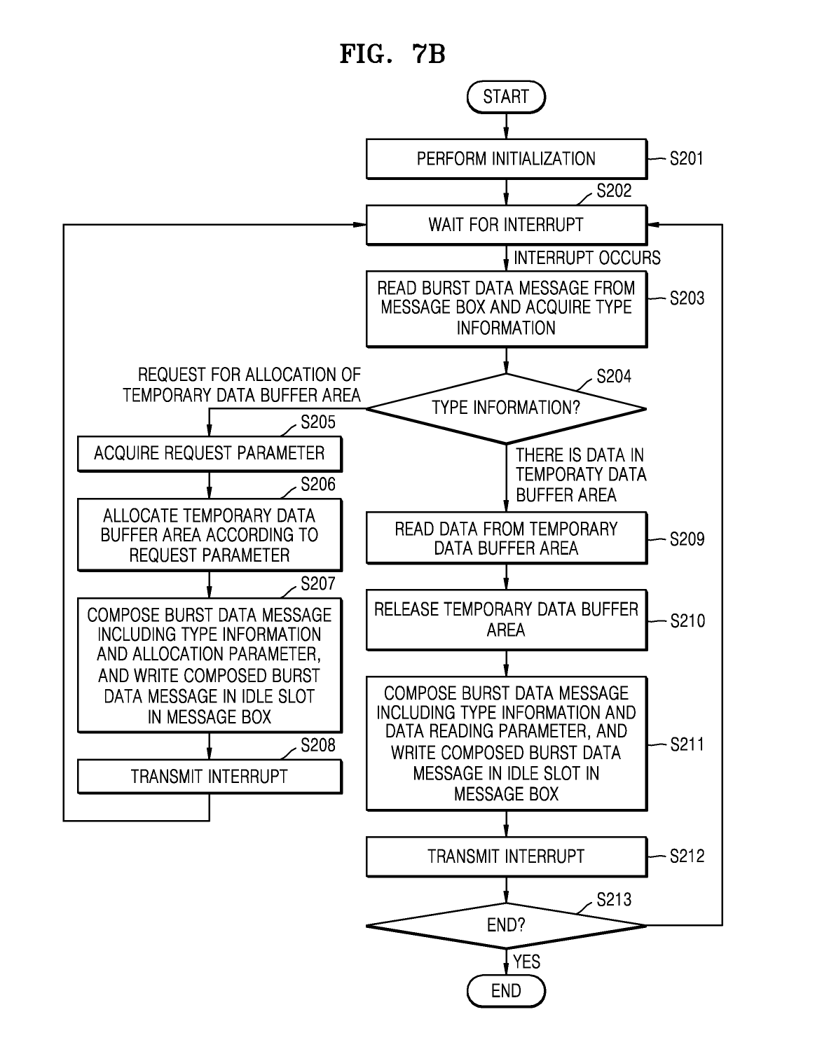

A communication method of a multi-processor communication system with respect to burst data will be described by referring to FIGS. 7A and 7B. FIG. 7A is a flowchart of an operation of a transmission processor of the multi-processor communication system sharing a physical memory with respect to the burst data, according to an exemplary embodiment. FIG. 7B is a flowchart of an operation of a reception processor of the multi-processor communication system sharing a physical memory with respect to the burst data, according to an exemplary embodiment.

In operation S101 of FIG. 7A, the first processor 100-1, which is, for example, the transmission processor, performs initialization. In operation S201 of FIG. 7B, the second processor 100-2, which is, for example, the reception processor, performs initialization.

Referring to FIG. 7A, in operation S102, the first processor 100-1 may compose one burst data message and write the composed burst data message in a specific idle slot in a message box. The burst data message may include type information indicating a burst data transmission event in which an allocation of a temporary data buffer area is requested, and a request parameter about the allocation of the temporary data buffer area. The type information is used to indicate the burst data transmission event. The request parameter may include a size of a buffer area which is to be allocated in response to the request, an application identifier, an identifier of the first processor 100-1, and an identifier of the second processor 100-2.

In operation S103, the first processor 100-1 transmits an interrupt to the second processor 100-2.

Referring to FIG. 7B, in operation S202, the second processor 100-2 waits for the interrupt transmitted by the first processor 100-1. When the second processor 100-2 receives the interrupt from the first processor 100-1, the second processor 100-2 reads the burst data message from the message box and acquires the type information in operation S203. In operation S204, the second processor 100-2 determines which types of burst data transmission events the type information indicates.

When it is determined in operation S204 that the type information indicates a burst data transmission event in which an allocation of a temporary data buffer area is requested, the second processor 100-2 acquires a request parameter related to the allocation of the temporary data buffer area in operation S205.

In operation S206, the second processor 100-2 allocates a temporary data buffer area according to the request parameter. For example, the second processor 100-2 may allocate a single buffer area as the temporary data buffer area.

In operation S207, the second processor 100-2 may compose one burst data message and write the composed burst data message in a specific idle slot of the message box. The burst data message may include type information indicating a burst data transmission event in which the temporary data buffer area is allocated, and an allocation parameter. The allocation parameter may include a size and a location of the allocated temporary data buffer area, an application identifier, an identifier of the first processor 100-1, an identifier of the second processor 100-2, etc.

In operation S208, the second processor 100-2 transmits an interrupt to the first processor 100-1. Then, the second processor 100-2 performs operation S202 again.

Referring to FIG. 7A again, in operation S104, the first processor 100-1 waits for the interrupt transmitted by the second processor 100-2. When the first processor 100-1 receives the interrupt from the second processor 100-2, the first processor 100-1 reads the burst data message from the message box and acquires the type information in operation S105. In operation S106, the first processor 100-1 determines which types of burst data transmission events the type information indicates.

When it is determined in operation S106 that the type information indicates the burst data transmission event in which the temporary data buffer area has been allocated, the first processor 100-1 acquires the allocation parameter related to the allocation of the temporary data buffer area in operation S107.

In operation S108, data is written in the temporary data buffer area according to the allocation parameter.

In operation S109, the first processor 100-1 may compose one burst data message and write the composed burst data message in a specific idle slot in the message box. The burst data message may include type information indicating a burst data transmission event in which data that is to be read is stored in the temporary data buffer area, and a data storage parameter. The data storage parameter may include an address of a temporary data buffer area, a length of the data that is to be read, an application identifier, an identifier of the first processor 100-1, an identifier of the second processor 100-2, etc.

In operation S110, the first processor 100-1 transmits an interrupt to the second processor 100-2. Then, the first processor 100-1 performs operation S104 again.

Referring to FIG. 7B again, when the second processor 100-2 receives the interrupt from the first processor 100-1, the second processor 100-2 reads the burst data message from the message box and recognizes the type information in operation S203. In operation S204, the second processor 100-2 determines which types of burst data transmission events the type information indicates.

When it is determined in operation S204 that the type information indicates the burst data transmission event in which the data that is to be read is stored in the temporary data buffer area, the data that is written by the first processor 100-1 is read from the temporary data buffer area in operation S209.

In operation S210, the temporary data buffer area is released.

In operation S211, the second processor 100-2 may compose one burst data message and write the composed burst data message in a specific idle slot in the message box in operation S211. The burst data message includes type information indicating that the data in the temporary data buffer area is read, and a data reading parameter. The data reading parameter may include an address of a temporary data buffer area, an application identifier, an identifier of the first processor 100-1, an identifier of the second processor 100-2, etc.

In operation S212, the second processor 100-2 transmits an interrupt to the first processor 100-1.

In operation S213, the second processor 100-2 determines whether to end the current data communication. When the second processor 100-2 determines to end the data communication, the second processor 100-2 ends the current data communication. When the second processor 100-2 determines not to end the data communication, the second processor 100-2 performs operation S202 again.

Referring to FIG. 7A again, in operations S104 and S105, when the first processor 100-1 receives an interrupt from the second processor 100-2, the first processor 100-1 reads a burst data message from the message box and recognizes type information. In operation S106, the first processor 100-1 determines which types of burst data transmission events the type information indicates.

When it is determined in operation S106 that the type information indicates a burst data transmission event in which the data in the temporary data buffer area has been read, the first processor 100-1 determines whether all data is transmitted in operation S111. If all data is transmitted, the first processor 100-1 ends the current data communication. If data remains to be transmitted, the first processor 100-1 performs operation S102 again.

When the burst data is transmitted according to the above described method, the transmission method is simple. Also, once the burst data transmission is requested, the requested temporary data buffer area is allocated in the burst data, and if the burst data transmission is not requested for a long period of time, the temporary data buffer area may be released, and thus, memory leakage may be prevented. Since it requires a certain degree of system load to allocate and release a temporary data buffer area, this communication method may be fitted to a data communication scenario accompanied by a lesser amount of data communication, which infrequently occurs, for example, burst data communication.

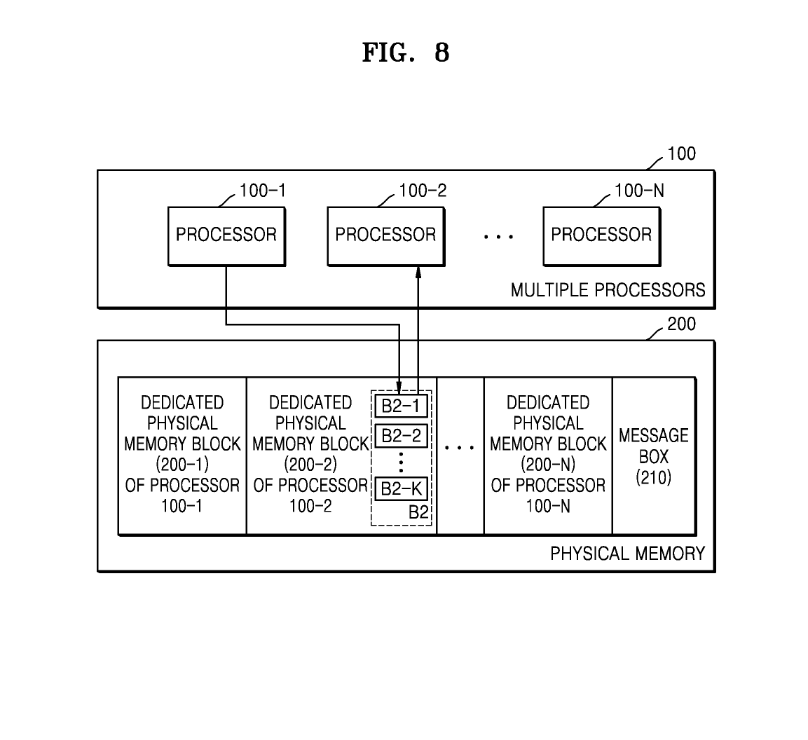

FIG. 8 is a view for describing an example of a multi-processor communication system sharing a physical memory with respect to stream data, according to an exemplary embodiment.

Referring to FIG. 8, when, for example, data that the transmission processor is to transmit to the reception processor is stream data, the temporary data buffer area B for buffering the stream data may include a cycle buffer area B2 formed of a plurality of fragments B2-1, B2-2, . . . , B2-K.

The stream data may be understood to indicate a data sequence which is sequentially transmitted. A stream data message including type information indicating a stream data transmission event may be temporarily stored in the message box 210 (see FIG. 5). For example, the stream data transmission event may include at least one of an event in which a stream link is requested to be established, an event in which the stream link is established, an event in which a state of a fragment is changed, an event in which the stream link is requested to be disconnected, and an event in which the stream link is disconnected.

When the stream data transmission event is the event in which the stream link is requested to be established, the stream data message may include a request parameter related to the request of the establishment of the stream link. The request parameter may include the number of fragments forming the requested cycle buffer area B2, a size of each fragment, an application identifier, an identifier of the transmission processor, and an identifier of the reception processor.

When the stream data transmission event is the event in which the stream link is established, the stream data message may include a unique identifier related to the stream link, which is used to globally and uniquely identify the established stream link, and an allocation parameter. The allocation parameter may include the number of fragments forming the allocated cycle buffer area B2, sizes, locations, and the number of fragments, an application identifier, an identifier of the transmission processor, and an identifier of the reception processor.

When the stream data transmission event is the event in which the stream link is requested to be disconnected, the stream data message may include a request parameter related to the disconnection of the stream link. The parameter related to the request of the disconnection of the stream link may include a unique identifier of the stream link, an application identifier, an identifier of the transmission processor, and an identifier of the reception processor.

When the stream data transmission event is the event in which the stream link is disconnected, the stream data message may include a parameter related to the disconnection of the stream link, which includes a unique identifier of the stream link, an application identifier, an identifier of the transmission processor, and an identifier of the reception processor.

The message box 210 may temporarily store a state message indicating a state of each fragment of the cycle buffer area B2. For example, the state message may indicate whether data that is to be read is stored in each fragment of the cycle buffer area B2 and a length of the data to be read. In other words, the state message may store whether buffered data exists in each fragment of the cycle buffer area B2. That is, the state message may store information indicating “data existing” or “data non-existing”, and a length of the data that to be read when the information indicates “data existing.”

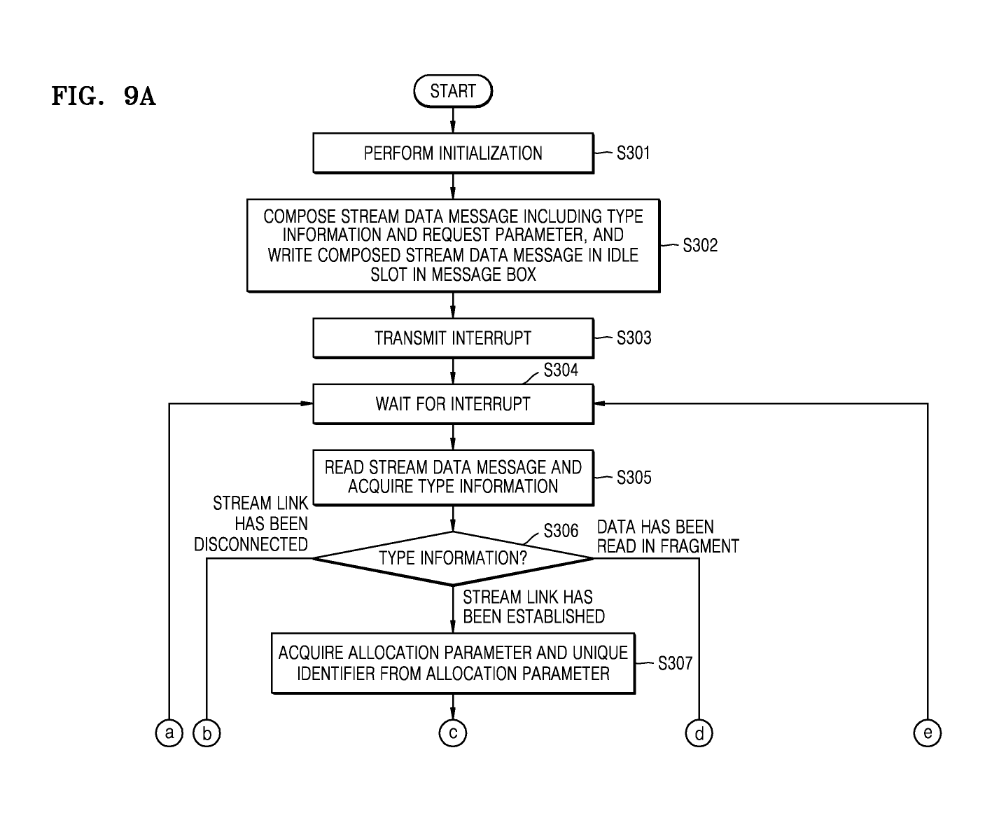

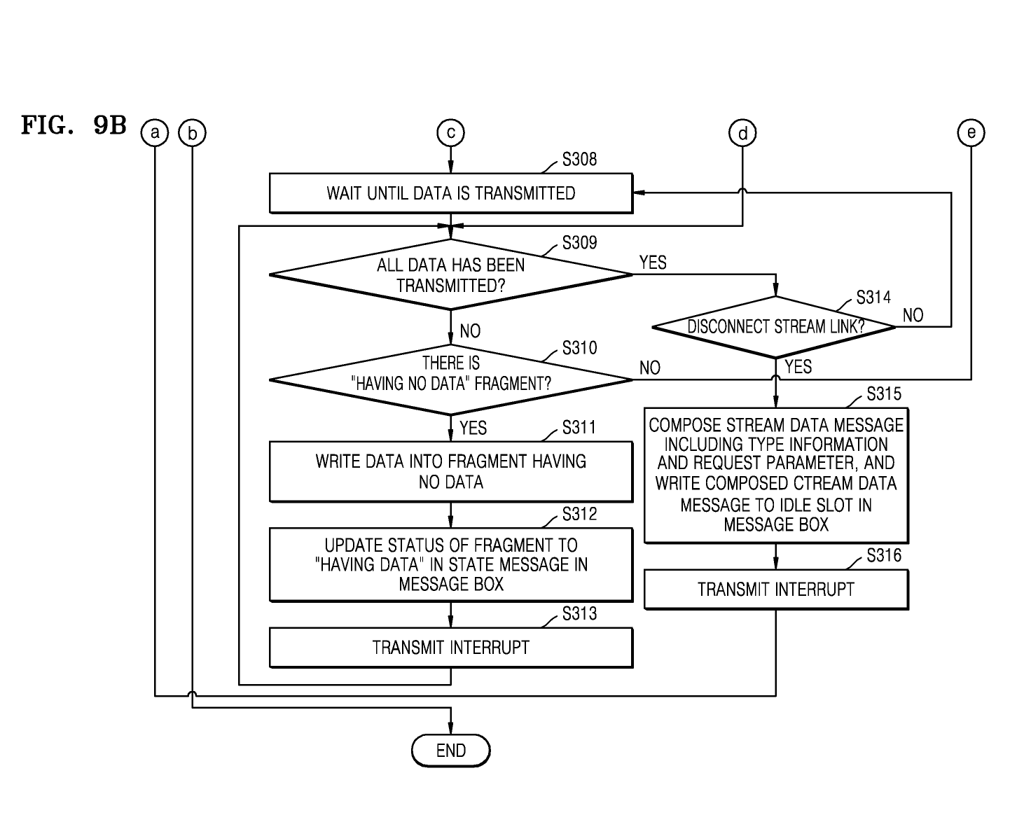

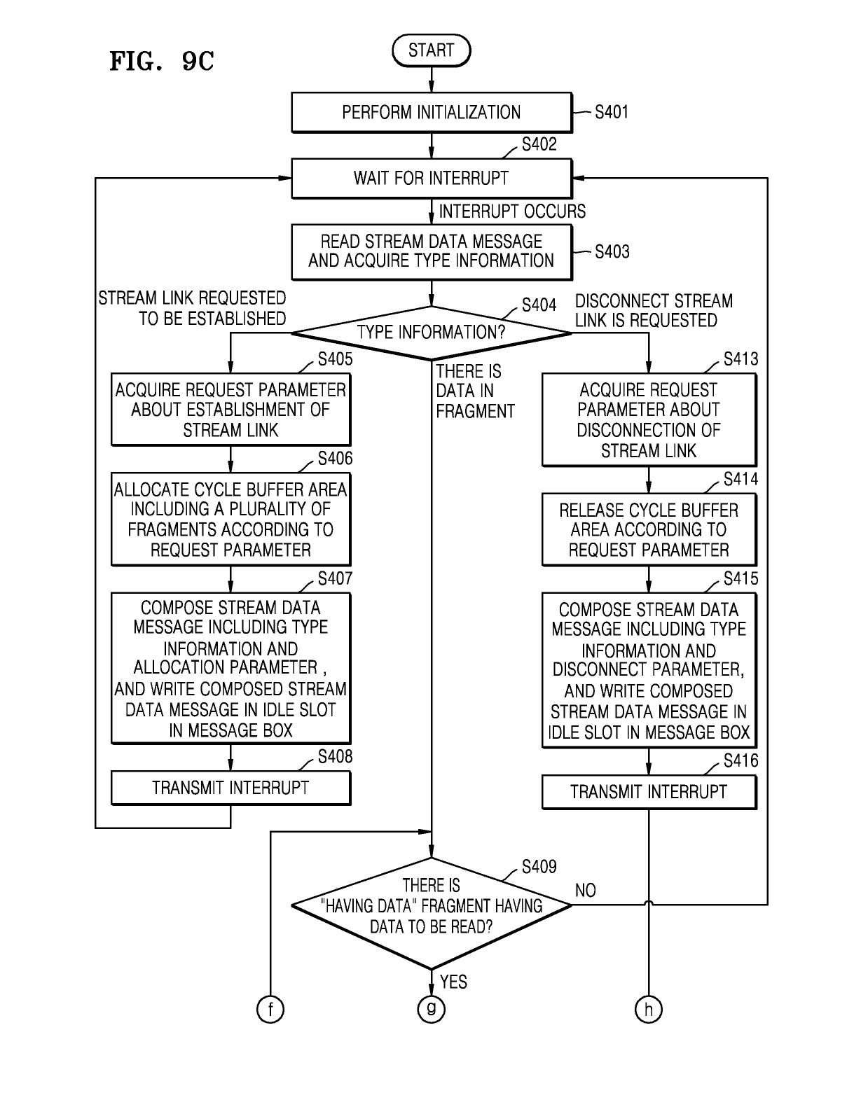

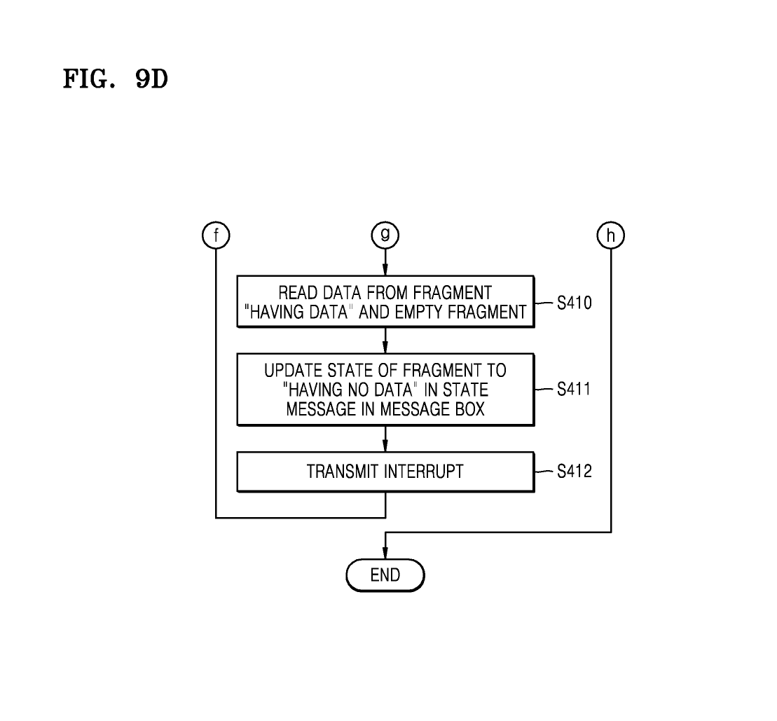

A communication method of a multi-processor communication system with respect to stream data will be described by referring to FIGS. 9A through 9D, according to an exemplary embodiment. FIGS. 9A and 9B are flowcharts of operations of a transmission processor in the multi-processor communication system sharing a physical memory with respect to the stream data according to an exemplary embodiment. FIGS. 9C and 9D are flowcharts of operations of a reception processor in the multi-processor communication system sharing a physical memory with respect to the stream data according to an exemplary embodiment.

In operation S301 of FIG. 9A, for example, the first processor 100-1, which is the transmission processor, performs initialization. In operation S401 of FIG. 9C, the second processor 100-2, which is the reception processor, performs initialization.

Referring to FIG. 9A, in operation S302, the first processor 100-1 may compose one stream data message and write the composed stream data message in a specific idle slot in a message box. The stream data message may include type information indicating a stream data transmission event in which the stream link is requested to be established, and a request parameter. Here, the type information is used to indicate the stream data transmission event. The request parameter may include the number of fragments in a requested cycle buffer area, a size of each fragment, an application identifier, an identifier of the first processor 100-1, and an identifier of the second processor 100-2.

In operation S303, the first processor 100-1 transmits an interrupt to the second processor 100-2.

Referring to FIG. 9C, in operation S402, the second processor 100-2 waits for the interrupt transmitted by the first processor 100-1.

When the second processor 100-2 receives the interrupt from the first processor 100-1, the second processor 100-2 reads the stream data message from the message box and acquires the type information in operation S403.

In operation S404, the second processor 100-2 determines which types of stream data transmission events the type information indicates.

When it is determined in operation S404 that the type information indicates the stream data transmission event in which the stream link is requested to be established, the second processor 100-2 acquires the request parameter related to the establishment of the stream link, in operation S405.

In operation S406, according to the request parameter, the cycle buffer area including the plurality of fragments is allocated.

In operation S407, the second processor 100-2 may compose one stream data message including an allocation parameter, and may write the composed stream data message in a specific idle slot in the message box. The allocation parameter may also include a unique identifier related to the stream link, type information indicating that the stream link is established, an application identifier, an identifier of the first processor 100-1, and an identifier of the second processor 100-2. The allocation parameter may include the number of fragments in the actually allocated cycle buffer area, sizes, and locations of fragments.

In operation S408, the second processor 100-2 may transmit an interrupt to the first processor 100-1 and may perform operation S402 again.

Referring to FIG. 9A again, in operation S304, the first processor 100-1 waits for the interrupt transmitted by the second processor 100-2.

When the first processor 100-1 receives the interrupt from the second processor 100-2, the first processor 100-1 may read the stream data message from the message box and acquire the type information, in operation S305.

In operation S306, the first processor 100-1 determines which types of stream data transmission events the type information indicates.

When the type information is determined in operation S306 to indicate the stream data transmission event in which the stream link has been established, the allocation parameter is acquired, and the unique identifier of the stream link is acquired from the allocation parameter. Additionally, an application identifier, and an actual allocation of the temporary data buffer area may also be acquired, and the number of fragments, and sizes and locations of the fragments may be obtained, in operation S307. The first processor 100-1 may again compose one state message including state information of each fragment in the cycle buffer area and write the composed state message in a specific idle slot in the message box. The state message exists in the slot to which the state message belongs during an entire data transmission cycle of the stream link, and the state message is not pre-requisite but optional. The first processor 100-1 and the second processor 100-2 may rapidly exchange the state information of each fragment in the cycle buffer area during the data transmission with the state message.

In operation S308 of FIG. 9B, the first processor 100-1 waits until data is transmitted.

In operation S309, whether all data is transmitted is determined.

If it is determined in operation S309 that data remains to be transmitted, the first processor 100-1 sequentially reads the state information of each fragment and determines whether there is a “having no data” fragment in operation S310. The “having no data” fragment indicates a fragment in which data does not exist (e.g., an empty fragment).

If it is determined that there is the “having no data” fragment (operation S309, YES), data is sequentially written in the fragment having no data in the cycle buffer area, in operation S311.

In operation S312, the state of the fragment is updated to “having data” in the state message in the message box, in order to reflect that the state of the fragment, including a length of the data that is to be read in the fragment, has changed, and updates type information indicating that the state of the fragment has changed, in order to indicate the data that is to be read is stored in the fragment.

In operation S313, the first processor 100-1 transmits an interrupt to the second processor 100-2, and performs operations from operation S309 again. In operation S310, when it is determined that there is no “having no data” fragment, the first processor 100-1 performs operation S304 again.

After the first processor 100-1 writes data in a “having no data” fragment B2-1 in operation S311, the first processor 100-1 updates state information of the fragment B2-1 temporarily stored in the state message as a state of “having data” including temporarily storing a length of data that is read in the fragment.

In operation S313, the first processor 100-1 transmits an interrupt to the second processor 100-2.

In operations S309 and S310, if the first processor 100-1 still has data that is to be written in the fragment and there is the “having no data” fragment, data may be sequentially written in the fragment. If the first processor 100-1 still has data to be written in the fragment in the case that all fragments are in the state of “having data,” the data write process into the fragment by the first processor 100-1 is stopped, and the first processor 100-1 returns to operation S304 and waits for the interrupt transmitted by the second processor 100-2.

If it is determined in operation S309 that all data has been transmitted, the first processor 100-1 determines whether to disconnect the stream link, in operation S314.

When it is determined that the stream link is to be disconnected (operation S314, YES), the first processor 100-1 composes a stream data message including the type information indicating “the request of the disconnection of the stream link,” and a request parameter. The request parameter may include a unique identifier of the stream link, an application identifier, an identifier of the first processor 100-1, an identifier of the second processor 100-2, etc., and writes the composed stream data message in a specific idle slot in the message box. If the state message is used in the data transmission processor, the state message is no longer requested, and the slot to which the state message belongs may be used to temporarily store the transmitted data.

In operation S316, the first processor 100-1 transmits an interrupt to the second processor 100-2, and performs operation S304 again.

Referring to FIG. 9C again, the second processor 100-2 waits for the interrupt transmitted by the first processor 100-1, in operation S402.

When the second processor 100-2 receives the interrupt from the first processor 100-1, the second processor 100-2 reads the stream data message from the message box and acquires the type information, in operation S403.

In operation S404, the second processor 100-2 determines which types of stream data transmission events the type information indicates.

When it is determined according to the type information in operation S404 that the stream data transmission event is an event in which the data to be read is stored in the fragment so that the state of the fragment is changed, the second processor 100-2 sequentially determines from the state message in the message box whether there is the “having data” fragment having the data to be read, in operation S409. Here, when the second processor 100-2 determines that there is the “having data” fragment having the data that is to be read, the second processor 100-2 may sequentially determine the state of the fragments by starting from the fragment of the data which is lastly read, rather than determine the state of each fragment from the first fragment.

When there is the fragment of “having data,” the second processor 100-2 reads data in the “having data” fragment, and empties the fragment, in operation S410 of FIG. 9D.

In operation S411, the state message in the message box is updated with the type information indicating that “the state of the fragment has changed,” in order to indicate that there is no data in the fragment, and the changed state of the fragment.

In operation S412, the second processor 100-2 transmits an interrupt to the first processor 100-1, and performs operation S409 again. That is, whenever the second processor 100-2 receives the interrupt notifying that the data that is to be read is stored in the fragment, from the first processor 100-1, the second processor 100-2 may sequentially read data in the “having data” fragment until there is no data which may be read, that is, until the “having no data” fragment is read. In this case, the second processor 100-2 stops reading the data, and performs operation S402 again to wait for the first processor 100-1 to transmit the interrupt again.

When the stream data transmission event is determined according to the type information to be the event in which the stream link is requested to be disconnected in operation S404, the second processor 100-2 acquires the request parameter related to the disconnection of the stream link in operation S413.

In operation S414, the cycle buffer area allocated according to the request parameter related to the disconnection of the stream link is released.

In operation S415, the second processor 100-2 composes a stream data message including the type information indicating “the disconnection of the stream link” and the disconnect parameter, and writes the composed stream data message in a specific idle slot in the message box. The disconnect parameter may include a unique identifier of the stream link, an application identifier, an identifier of the first processor 100-1, an identifier of the second processor 100-2, etc.

In operation S416, the second processor 100-2 transmits an interrupt to the first processor 100-1. Finally, the current data communication is finished.

Referring to FIG. 9A again, the first processor 100-1 waits for the interrupt transmitted by the second processor 100-2, in operation S304.

When the first processor 100-1 receives the interrupt from the second processor 100-2, the first processor 100-1 reads the stream data message and acquires the type information, in operation S305.

In operation S306, the first processor 100-1 determines which types of stream data transmission events the type information indicates. When it is determined according to the type information in operation S306 that the stream data transmission event is the event in which the data is read in the fragment, operation S309 is performed. When it is determined according to the type information in operation S306 that the stream data transmission event is the event in which the stream link is disconnected, the current data communication is ended.

The stream data transmitted according to the above described method is circularly and repeatedly stored in the cycle buffer area, and thus, it is not required to frequently allocate and release the buffer area. Accordingly, a communication efficiency is improved. This type of communication method is suitable to a data transmission scenario in which a large volume of data is frequently transmitted. The management strategy of the stream link may effectively prevent a memory leakage. For example, when a party participating in communication does not have to perform communication any more, the other party may request a disconnection of the stream link, and the data reception processor responding to the allocation of the buffer area may immediately release the cycle buffer area, and thus, memory leakage may be prevented, and an error, such as a system collision in the data reception processor, may be prevented.

According to the multi-processor communication system sharing a physical memory and the communication method, it is not required to reserve a globally-shared memory area, and the plurality of processors may transmit data to one another via dedicated physical memory blocks corresponding thereto, and thus, a memory use efficiency may be increased. In addition, during the data transmission, the number of times in which the data is copied is reduced, and thus, a data transmission speed may be increased.

While the inventive concept has been particularly shown and described with reference to exemplary embodiments thereof, it will be understood that various changes in form and details may be made therein without departing from the spirit and scope of the following claims.

What is claimed is:

1. A multi-processor communication system sharing a physical memory, the multi-processor communication system comprising:
a plurality of processors configured to share data with one another; and
the physical memory divided into a plurality of physical memory blocks,
wherein each of the plurality of processors has one dedicated physical memory block among the plurality of physical memory blocks,
wherein a processor among the plurality of processors is configured, as a transmission processor, to transmit data to a dedicated physical memory block of another processor among the plurality of processors, which is configured, as a reception processor, to receive data, and
wherein the reception processor reads the data from the dedicated physical memory block of the reception processor.

2. The multi-processor communication system of claim 1, wherein the transmission processor is configured to request the reception processor to allocate a temporary data buffer area for buffering data in the dedicated physical memory block of the reception processor, and
the reception processor is configured to allocate the temporary data buffer area in response to the request of the transmission processor.

3. The multi-processor communication system of claim 2, wherein the data is burst data, and the temporary data buffer area for buffering the burst data comprises a single buffer area.

4. The multi-processor communication system of claim 2, wherein the data is stream data, and the temporary data buffer area for buffering the stream data comprises a cycle buffer area comprising a plurality of fragments.

5. The multi-processor communication system of claim 3, further comprising a message box for temporarily storing a burst data message comprising type information indicating a burst data transmission event.

6. The multi-processor communication system of claim 5, wherein the message box is a dedicated area divided from the physical memory or a dedicated hardware register provided in the multi-processor communication system.

7. The multi-processor communication system of claim 4, further comprising a message box for temporarily storing a stream data message comprising type information indicating a stream data transmission event.

8. The multi-processor communication system of claim 7, wherein the message box is a dedicated area divided from the physical memory or a dedicated hardware register provided in the multi-processor communication system.

9. The multi-processor communication system of claim 1, wherein the multi-processor communication system is integrated into a single chip system or into a multi-processor system sharing a multi-port physical memory.

10. A communication method of a multi-processor communication system which comprises a physical memory and a plurality of processors exchanging data with each other and sharing the physical memory, the communication method comprising:
dividing the physical memory into a plurality of physical memory blocks so that each of the processors has one dedicated physical memory block among the plurality of physical memory blocks;
requesting an allocation of a temporary data buffer area for buffering the data in a dedicated physical memory block of a reception processor, which receives data, from among the plurality of processors, the requesting being performed by a transmission processor, which transmits the data, from among the plurality of processors;
allocating the temporary data buffer area in response to the request of the transmission processor, the allocating being performed by the reception processor;
transmitting the data to the allocated temporary data buffer area, the transmitting being performed by the transmission processor, and
reading the data from the allocated temporary data buffer area, the reading being performed by the reception processor.

11. The communication method of claim 10, further comprising setting a dedicated physical area of the physical memory as a message box so that messages comprising commands and responses between the transmission processor and the reception processor are loaded in the message box.

12. The communication method of claim 11, wherein, when the data is burst data which is transmitted in a burst mode, the temporary data buffer area comprises a single buffer area.

13. The communication method of claim 12, wherein a burst data message indicating a burst data transmission event is temporarily allocated and released in the single buffer area.

14. The communication method of claim 11, wherein when the data is stream data which is sequentially transmitted, the temporary data buffer area comprises a cycle buffer area comprising a plurality of fragments.

15. The communication method of claim 14, wherein a stream data message indicating a stream data transmission event is circularly and repeatedly allocated in the cycle buffer area.

16. A multi-processor communication system comprising:
a first processor;
a second processor that exchanges data with the first processor; and
a physical memory,
wherein the second processor has one dedicated physical memory block in the physical memory, and
wherein the second processor temporarily allocates a temporary data buffer area of its dedicated physical memory block for receiving data transmitted only from the first processor.

17. The multi-processor communication system of claim 16, wherein the second processor reads the data from the temporary data buffer area.

18. The multi-processor communication system of claim 16, wherein the second processor releases the temporary data buffer area.

19. The multi-processor communication system of claim 16, wherein the physical memory is divided into a plurality of physical memory blocks, each of the first processor and the second processor having one dedicated physical memory block among the plurality of memory blocks, and
wherein the first processor transmits data to the dedicated physical memory block of the second processor, and the second processor reads the data from the dedicated physical memory block of the second processor.

20. The multi-processor communication system of claim 19, wherein the second processor transmits data to the dedicated physical memory block of the first processor, and the first processor reads the data from the dedicated physical memory block of the first processor.
